(19) United States
(12) Patent Application Publication
(10) Pub. No.: US 2014/0067477 A1
(43) Pub. Date: Mar. 6, 2014

(54) Systems and Methods for Shopping Trend Alert

(71) Applicant: Lucy M. Zhao, Austin, TX (US)

(72) Inventor: Lucy M. Zhao, Austin, TX (US)

(73) Assignee: eBay, Inc., San Jose, CA (US)

(21) Appl. No.: 13/596,655

(22) Filed: Aug. 28, 2012

(51) Int. Cl. G06Q 30/02

(52) U.S. Cl. 705/7.34

(57) ABSTRACT

Systems and methods are disclosed for running a product trend application on a user device to obtain personalized product trend information from a service provider when making in-store purchase decisions. The user may use the product trend application to specify product trend information for products in a product category, for products purchased from a specific store, and/or for products purchased over a specified time period. The user device may obtain and transmit its current location to the service provider, which may provide a list of stores in the vicinity of the user device for which the product trend information is available. The user may also use the product trend application to select how the product trend information is filtered and displayed. Advantageously, the user may tailor the product trend information to the requirements of the user, such as to find the most popular product in a product category.

### TECHNICAL FIELD

The present disclosure relates generally to use of a mobile device to assist consumers in making purchase decisions. In particular, the present disclosure relates to methods and systems for using mobile devices to obtain trends in product preferences to help consumers make in-store purchase decisions.

### BACKGROUND

Shoppers face many decisions when selecting products to purchase. Frequently, a shopper's decision to purchase a specific product is influenced by product trends or data on product preferences of other shoppers. Such product trends may indicate the latest hot gadgets in electronic products or the latest fashion in apparel. Shoppers who do not want to be left behind in the latest in product trends may need information on which products in a product segment are in demand. Information on product trends may be available online for products across different product categories. However, such information tends to cover products in broad product categories, for products sold across large geographic regions, or may not cover the latest time period. Therefore, there is a need for consumers to be able to effectively and efficiently obtain product trend information that is tailored to the needs of the consumers when the consumers are in the stores ready to make purchase decisions.

### BRIEF DESCRIPTION OF THE DRAWINGS

FIG. 1 shows a system for a product trend application of a user device in communication with product trend information databases of a payment service provider for obtaining product trend information according to one or more embodiments of the present disclosure;

FIG. 2 shows a flow chart of the steps for running the product trend application on the user device to obtain personalized product trend information from the payment service provider of FIG. 1 according to one or more embodiments of the present disclosure;

FIG. 3 shows a flow chart of the steps for the payment service provider to provide personalized product trend information to the user device of FIG. 1 according to one or more embodiments of the present disclosure;

FIG. 4 shows a sequence of displays from a product trend application running on a user device for a user to specify requirements for personalized product trend information and to display the information according to one or more embodiments of the present disclosure; and

FIG. 5 is a block diagram of a computer system suitable for implementing one or more components discussed herein according to one embodiment of the present disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

Systems and methods are disclosed herein for running a product trend application on a user device to enable a user to obtain personalized product trend information when making in-store purchase decisions. The product trend application and the personalized product trend information may be provided by a payment service provider such as PayPal, Inc. of San Jose, Calif. The user may use the product trend application to specify product trend information for products in a product category, for products purchased from a specific store, and/or for products purchased over a specified time period. To aid the user in designating a store for which to provide the product trend information, the user device may obtain its current location and transmit the location information to the payment service provider. The payment service provider may provide a list of stores in the vicinity of the user device for which the product trend information is available. The user may also use the product trend application to select how the product trend information is filtered and displayed. Such filtering may allow the user to select trend categories such as a listing of the most popular products, to select the number of products in the trend category to display, and to select the presentation style of the display. Advantageously, the user may tailor the product trend information to the requirements of the user.

The payment service provider may provide the product trend information from databases. Such databases may include a store location database to provide information on stores in the vicinity of the user device. A list of stores in the vicinity of the user device may be provided to the user device to aid the user in specifying a store for which product trend information is requested. In addition, there may be a database of product purchase history used to provide information on products in selected categories purchased from the specified store over a specified period of time. The database of product purchase history may be compiled by the payment service provider based on information received when the payment service provider processes payment transactions made by consumers from the stores in the store location database.

In accordance with one or more embodiments of the present disclosure, an apparatus is disclosed. The apparatus includes one or more processors. The apparatus also includes a database for storing information on stores and on products purchased from the stores. The apparatus further includes a memory that stores machine-readable instructions for execution by the processors to provide product trend information. The apparatus receives from a communication device the device's location. The apparatus also searches the database to obtain information on stores in the vicinity of the device. The apparatus further transmits the information on the stores in the vicinity of the device to the device. The apparatus further receives from the device selections for product trend information for one of the stores in the vicinity of the device. The apparatus further searches the information on products purchased from the selected store in the database to obtain the product trend information. The product trend information is obtained for products that satisfy the selections for product trend information. The apparatus further transmits the product trend information to the device.

In accordance with one or more embodiments of the present disclosure, an apparatus is disclosed. The apparatus includes one or more processors. The apparatus also includes a memory that stores machine-readable instructions for execution by the processors to receive product trend information. The apparatus transmits the location of the apparatus to a service provider. The apparatus also receives from the service provider store information on stores in the vicinity of the location of the apparatus. The apparatus further identifies a store and selections for product trend information for products purchased from the identified store based on the received store information. The apparatus further transmits to the service provider a request for product trend information. The request includes the identified store and the selections for product trend information for products purchased from the identified store. The apparatus further receives from the service provider the requested product trend information for products purchased from the identified store. The products purchased from the identified store satisfy the selections for product trend information. The apparatus further processes the product trend information in accordance with selections for display filters to display the product trend information.

In accordance with one or more embodiments of the present disclosure, a method for running a product trend application on a processor to provide product trend information is disclosed. The method includes receiving by the processor a location of a device. The method also includes searching by the processor a database to obtain stores in the vicinity of the device location. The method further includes transmitting by the processor store information on the stores to the device. The method further includes receiving by the processor selections for product trend information on products purchased from a store in the vicinity of the device location. The method further includes searching the database by the processor to obtain product trend information on products purchased from the identified store. The product trend information is obtained for products that satisfy the selections for product trend information. The method further includes transmitting by the processor the product trend information to the device.

In accordance with one or more embodiments of the present disclosure, a method for running a product trend application on a communication device to receive product trend information is disclosed. The method includes obtaining by the communication device a device location. The method also includes transmitting by the communication device the device location to a provider of product trend information. The method further includes receiving by the communication device store information on stores in the vicinity of the device location. The method further includes identifying by the communication device a store and selections for product trend information for products purchased from the identified store based on the received store information. The method further includes transmitting by the communication device a request for product trend information to the provider. The request includes the identified store and the selections for product trend information for products purchased from the identified store. The method further includes receiving by the communication device the product trend information for products purchased from the identified store. The products purchased from the identified store also satisfy the selections for product trend information. The method further includes processing by the communication device the product trend information in accordance with selections for display filters to display the product trend information.

In accordance with one or more embodiments of the present disclosure, a non-transitory computer readable medium having computer readable code for execution by a processor to perform a method is disclosed. The method includes receiving a location of a device. The method also includes searching a database to obtain stores in the vicinity of the device location. The method further includes transmitting store information on the stores to the device. The method further includes receiving selections for product trend information on products purchased from a store in the vicinity of the device location. The method further includes searching the database to obtain product trend information on products purchased from the identified store. The product trend information is obtained for products that satisfy the selections for product trend information. The method further includes transmitting the product trend information to the device.

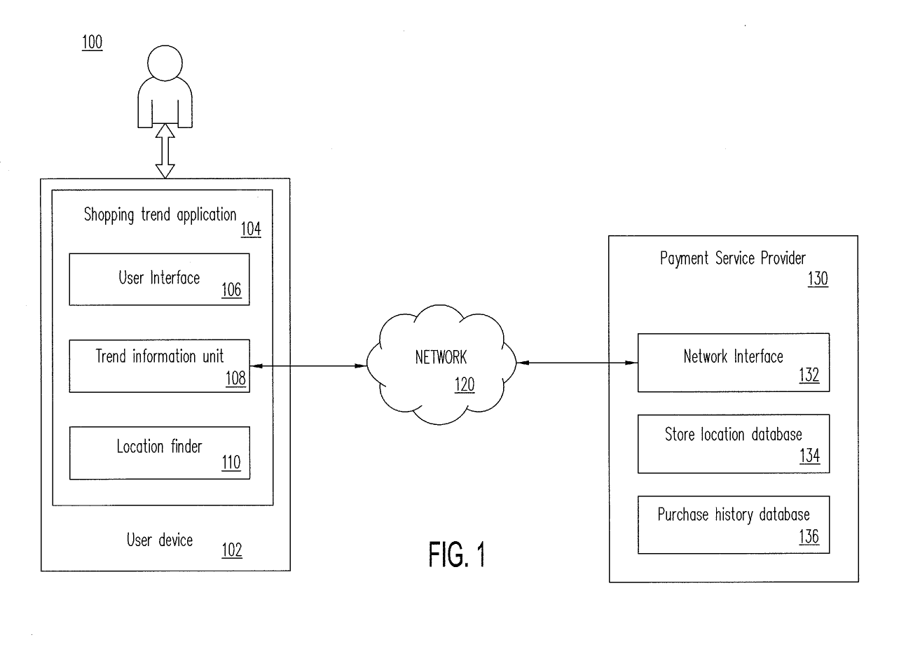

Refer now to the figures wherein the drawings are for purposes of illustrating embodiments of the present disclosure only, and not for purposes of limiting the same. FIG. 1 shows a system for a product trend application of a user device in communication with product trend information databases of a payment service provider for obtaining product trend information according to one or more embodiments of the present disclosure.

A user 100 has a user device 102 on a shopping trip. When user 100 sees or is near a store, user 100 may start shopping trend application 104 on user device 102 to obtain product trend information for the store. In another embodiment, user 100 may launch shopping trend application 104 without being near a store, such as by specifying a specific shopping location or store that the user intends to go to.

User device 102 that runs shopping trend application 104 may be a smart phone (e.g., iPhone, Google phone, or other phones running Android, Window Mobile, or other operating systems), a tablet computer (e.g., iPad, Galaxy), personal digital assistant (PDA), a notebook computer, or various other types of wireless or wired computing devices. It should be appreciated that user device 102 may be referred to as a client device or a customer device without departing from the scope of the present disclosure. User device 102 may communicate over a network 120 with payment service provider 130.

Network 120 may be implemented as a single network or a combination of multiple networks. For example, in various embodiments, network 120 may include the Internet and/or one or more intranets, wireless networks (e.g., cellular, wide area network (WAN), WiFi hot spot, WiMax, personal area network (PAN), Bluetooth, etc.), landline networks and/or other appropriate types of communication networks. As such, in various embodiments, user device 102 may be associated with a particular link (e.g., a link, such as a URL (Uniform Resource Locator) to an IP (Internet Protocol) address).

Shopping trend application 104 may include a user interface 106, a trend information unit 108, and a location finder 110. User interface 106 enables user 100 to interact with shopping trend application 104 to tailor user requests for product trend information. For example, user 100 may use user interface 106 to specify the product categories, the stores, and the time periods for which product trend information is desired. User interface 106 also allows user 100 to select how the product trend information is filtered for presentation on user device 102. For example, user 100 may select trend categories based on the number of total units sold, or the percentage of increase in the number of units sold, etc. User 100 may also specify the number of products to display and select the display style. Thus, using user interface 106, user 100 may display in a bar graph the ten most popular products in a product category sold at a store for the last month. In other embodiments, payment service provider 130 may provide suggestions for product trend information based on system defaults or user history or preferences.

Inputting of user selection may be done in any number of ways. In one example, user 100 may manually type in a selection such as a time period over which the product trend information is desired using a keypad or keyboard. In another example, user 100 may select items from a list, such as a drop down menu of trend categories or a drop down menu of product categories specific to a store. In another example, user 100 may use a touch-screen to select a store on a map displaying the current location of user 100 and the stores in the vicinity of user 100. In one or more embodiments, user interface 106 includes a software program, such as a graphical user interface (GUI), executable by a processor and configured to interface with user 101.

Trend information unit 108 interfaces with network 120 to enable shopping trend application 104 to communicate with payment service provider 130. For example, trend information unit 108 transmits user selections and the current location of user device 102 to payment service provider 130. Trend information unit 108 also receives and processes product trend information and information on the stores in the vicinity of user 100 from payment service provider 130 for display to user 100. In one or more embodiments, trend information unit 108 receives the current location of user device 103 from location finder 110 for transmission to payment service provider 130. After receiving from payment service provider 130 a list of stores in the vicinity of user device 102 for which product trend information is available, trend information unit 108 displays the stores on a map. “Vicinity” may be defined by user 100 or determined by payment service provider 130, such as based on user location. For example, in a sparsely populated shopping area, stores in the vicinity of user device 102 may be at a greater distance than in a densely populated shopping area. User 100 may select a store on the map and may request product trend information for a product category of products sold at the selected store covering a time period. Trend information unit 108 receives the user selections from user interface 106 and transmits the user selections to payment service provider 130. User 100 may further use display filters on user interface 106 to select a trend category and a display style to display the product trend information. Trend information unit 108 receives the product trend information from payment service provider 130 and the display filter selections from user interface 106. Trend information unit 108 processes the product trend information using the display filter selections to filter the product trend information for display to user 100.

Location finder 110 obtains information on the current location of user device 102 to aid user 100 in selecting the store for which to request product trend information. Location finder 110 may be implemented as a GPS receiver, may derive the location of user device 102 from network 120 using known locations of WiFi hotspots, cellular base-stations, or may receive the location information from an external source.

Payment service provider 130 receives and services requests for product trend information from user device 102. Payment service provider 130 may include a network interface 132, a store location database 134, and a purchase history database 136. Network interface 132 interfaces with network 120 to exchange information with user device 102. For example, network interface 132 receives information on the location of user device 102. In response, network interface 132 transmits information on stores in the vicinity of user device 102 for which product trend information is available. Network interface 132 also receives user selections such as selections for stores, product categories, and/or a time period for which product trend information is requested. In response, network interface 132 may transmit product trend information for a product category of products purchased at a store covering a time period.

Store location database 134 provides the information on the stores in the vicinity of user device 102 for which product trend information is available. The store information may include the names of the stores and the product categories of products carried by the stores. The number of the product categories and their associated granularity may be a function of the size and the type of a store. For example, a video game store may have product categories for video games where the product categories are broken down by the targeted age groups of the video games. On the other hand, a general merchandising retailer may have general product categories for consumer electronics, clothing, household items, etc. The general product categories may be further broken down into narrower groups of products. For example, under consumer electronics there may be subcategories for TVs, laptops, smart phones, etc. In one or more embodiments, store location database 134 may compile the product categories from information provided by stores when payment service provider 130 processes payment transactions for the stores. For example, when payment service provider 130 processes payments for purchases made at the video game store, the store may provide information on the product categories of the video games purchased. Payment service provider 130 may compile the product category information for the stores for storage into store location database 134.

When network interface 132 receives information on the location of user device 102, network interface 132 may query store location database 134 for information on stores in the vicinity of the received location. Store location database 134 may search for stores located within a given radius of the received location and may return information for those stores for which product trend information is available from purchase history database 136. The search radius may be defined by payment service provider 130 or may be selectable by user 100 through user interface 106 of user device 102. Network interface 132 receives the store information from store location database 134 and transmits the store information to user device 102.

Purchase history database 136 provides the product trend information for the selected product categories, stores, and/or time periods received from user device 102. Similar to store location database 134 compiling the product categories from information provided by stores, product history database 136 may compile the product trend information from information provided by stores when payment service provider 130 processes payment transactions for the stores. For example, when payment service provider 130 processes payments for purchases made at the video game store, the store may provide information for the name, the quantity, the price, and the product category of each video game purchased, along with the date of transaction and the store name. This information may be stored into purchase history database 136.

When payment service provider 130 receives a request for product trend information for a product category for a store over a period of time, purchase history database 136 is searched for purchases that meet the criteria. Purchase history database 136 may compile the information for the purchases found to generate the product trend information. For example, when user 100 requests product trend information for video games for children 12 and under purchased from the video game store over the last month, purchase history database 136 is searched for purchases that meet the criteria. Purchase history database 136 may compile the information found to generate a listing of the names and the quantities of the video games for children 12 and under purchased from the video game store for the last month. Network interface 132 may receive the listing from purchase history database 136 and may transmit the listing as the product trend information to user device 102.

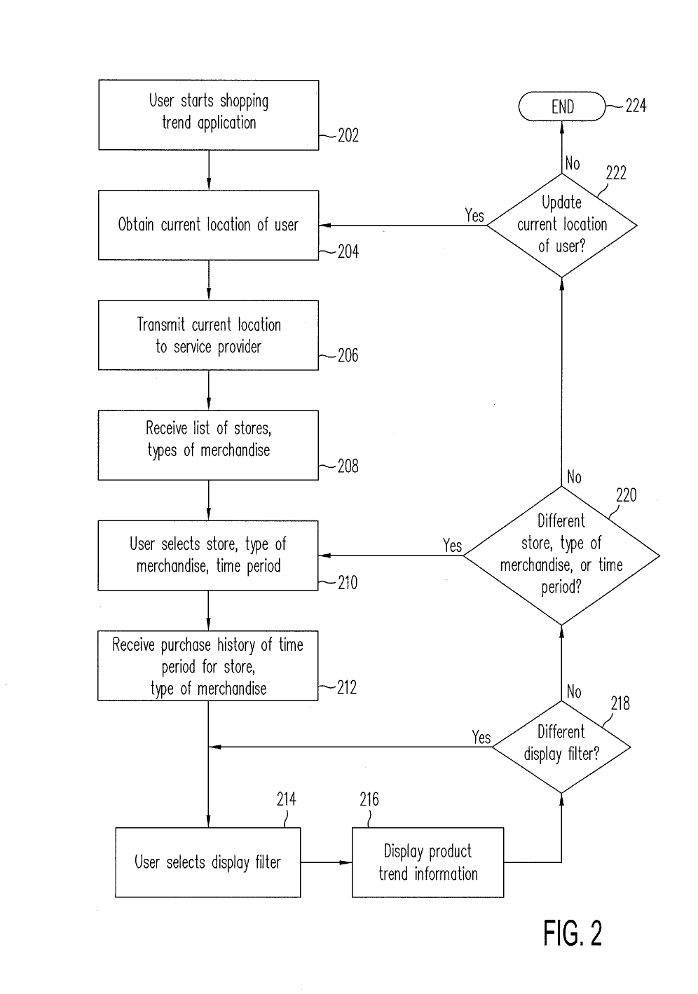

FIG. 2 shows a flow chart of the steps for running the product trend application on the user device to obtain personalized product trend information from the payment service provider of FIG. 1 according to one or more embodiments of the present disclosure.

User 100 goes shopping and approaches a store for which user 100 is interested in obtaining product trend information. In step 202, user 100 starts shopping trend application 104 on user device 102. In step 204, shopping trend application 104 directs location finder 110 to obtain the current location of user device 102. Location finder 110 may obtain the current location independently, with assistance from network 120, or from external sources. In step 206, shopping trend application 104 transmits the current location of user device 102 to payment service provider 130 to obtain information on stores in the vicinity of user 100. Payment service provider 130 may provide information for one or more stores for which product trend information is available and where the stores are located within a certain radius of user 100. The radius may be selected by user 100 through user interface 106, or may be determined by payment service provider 130. The store information provided by payment service provider 130 may contain the names of the stores, their locations, and the product categories of products carried by the stores.

In step 208, user device 102 receives the store information and may display the store locations along with the current location of user 102 on a map. User device 102 may also display a menu listing of the stores and the product categories of products carried by the stores for selection by user 100. In step 210, if the menus displays the store that user 100 is interested in obtaining product trend information, user 100 selects the store and a product category. If the store that user 100 is interested in is not displayed, possibly because payment service provider 130 does not have the product trend information for that store, user 100 may select another store for which product trend information is available. Alternatively, if the store is displayed, but it does not have the desired product category because payment service provider 130 does not have the product trend information for that product category, user 100 may select another product category or another store for which product trend information is available. In addition to selecting the store and the product category, user 100 may also specify the time period covered by the product trend information. These selections are transmitted from user device 102 to payment service provider 130 to request the product trend information for the selections. As an example, user 100 may select a video game store, a product category for video games for children 12 under, and may specify last month as the time period. These selections are transmitted from user device 102 to payment service provider 130 to request product trend information for video games for children 12 and under purchased from the video game store over the last month.

In step 212, user device 102 receives the requested product trend information for the selected store, product category, and/or the specified time period. The product trend information may include a listing of the names, the unit prices, the purchase dates, and the quantities of products for the selected product category that were purchased from the store covering the specified time period. In step 214, user 100 selects display filters on shopping trend application 104 to specify how the product trend information is to be processed and displayed. The display filter may include selections for a trend category, for the number of products to display, and for a display type. For example, under the trend category, there may be selections to process the product trend information to display the most popular products as determined by the quantities sold, to display the products with the largest percentage increase in the quantities sold from the beginning to the end of the time period, or to display the products with the largest price increase from the beginning to the end of the time period, etc. Under the selections for the number of products to display, user 100 may specify the number of products to display for the selected trend category. Under the display type, user 100 may elect to display the selected trend category in a bar graph, a pie chart, or a table, etc. As an example, user 100 may use the display filters to specify that shopping trend application 104 displays in a bar graph the ten most popular video games for children 12 and under purchased from the video game store over the last month.

In step 216, shopping trend application processes and displays the product trend information in accordance with the selected display filters. User 100 may use the product trend information to assist in making purchase decisions. For example, if user 100 is interested in purchasing a video game for children 12 and under, user 100 may make the purchase decision based on what are the ten most popular video games in that category over the last month purchased from the store.

In step 218, if user 100 is interested in selecting a different set of display filters to process and display the same product trend information, user 100 repeats steps 214-216 to specify the new display filters and to display the product trend information based on the new selections. For example, user 100 may specify that shopping trend application 104 displays in a bar graph the ten products having the largest percentage increase in the quantities sold from the beginning to the end of the specified time period. In step 220, if user 100 is interested in obtaining different product trend information, such as that for another store, in another product category, or for a different time period, user 100 repeats steps 210-216 to make new selections to obtain and display new product trend information based on the new selections. In step 222, if user wants to update the current location or to increase the search radius around the current location so as to find new stores to obtain product trend information, user 100 repeats steps 204-216 to obtain and display product trend information for the new stores. Note that one or more of the steps described herein may be omitted, combined, and/or performed in a different sequence as desired.

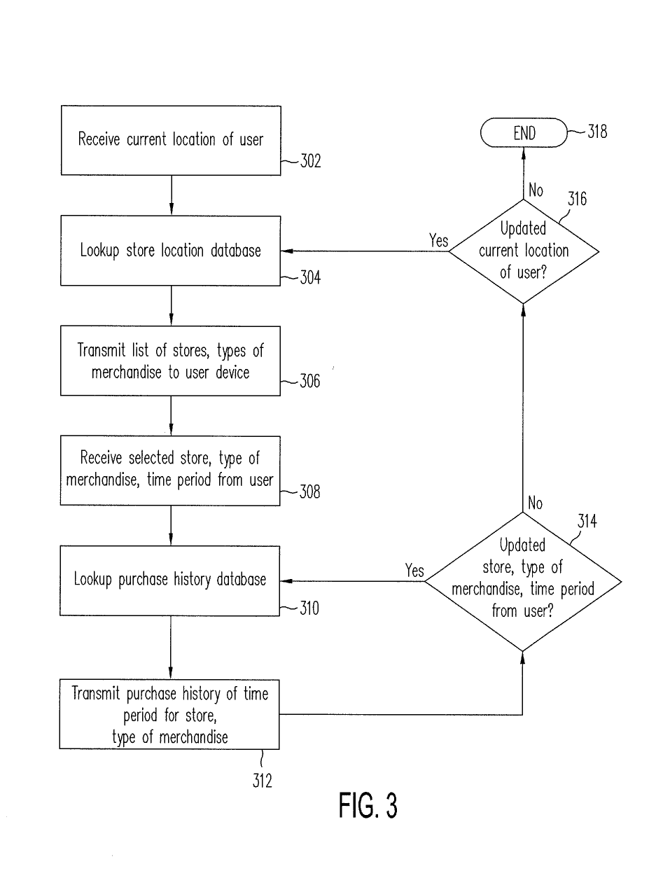

FIG. 3 shows a flow chart of the steps for the payment service provider to provide personalized product trend information to the user device of FIG. 1 according to one or more embodiments of the present disclosure.

In step 302, payment service provider 130 receives a current location of user device 102 as part of a request for product trend information. In step 304, payment service provider 130 accesses store location database 134 to search for information on stores in the vicinity of the current location of user device 102. In one or more embodiments, payment service provider 130 may search for stores located within a certain radius of the current location of user device 102. The search radius may be received from user device 102 or may be selected by payment service provider 103. The results of the search may be a listing of the names of the stores, their locations, and the product categories of products carried by the stores for which payment service provider 130 may provide product trend information. In step 306, payment service provider 106 transmits the list of stores and the product categories associated with the stores to user device 102.

In step 308, payment service provider 130 receives a request from user device 102 to provide product trend information for a product category of products purchased from a store over a specified time period. In step 310, payment service provider 130 accesses purchase history database 136 to search for information on products belonging to the product category purchased from the store where the purchase occurred within the specified time period. The product information from the search may be a listing of the names, the unit prices, the purchase dates, and the quantities of products that satisfy the search criteria. In step 312, the product information from the search may be transmitted to user device 102 for user device 102 to process in accordance with display filters selected by user 100 to display the product trend information. In one or more embodiments, processing of the product information to generate the product trend information may be performed by payment service provider 130. As such, display filters may be transmitted from user device 102 to payment service provider 130 for payment service provider 130 to process the product information in accordance with the received display filters to generate the product trend information. The product trend information may then be transmitted to user device 102 for display.

In step 314, if payment service provider 130 receives a request from user device 102 to provide product trend information for a different product category, for a different store, or over a different time period, payment service provider 130 repeats steps 310-312 to provide new product trend information to user device 102. In step 316, if payment service provider 130 receives an updated location of user device 102, or a request to increase the search radius around the current location of user device 102 to find new stores to obtain product trend information, payment service provider repeats steps 304-312 to provide product trend information for the new stores.

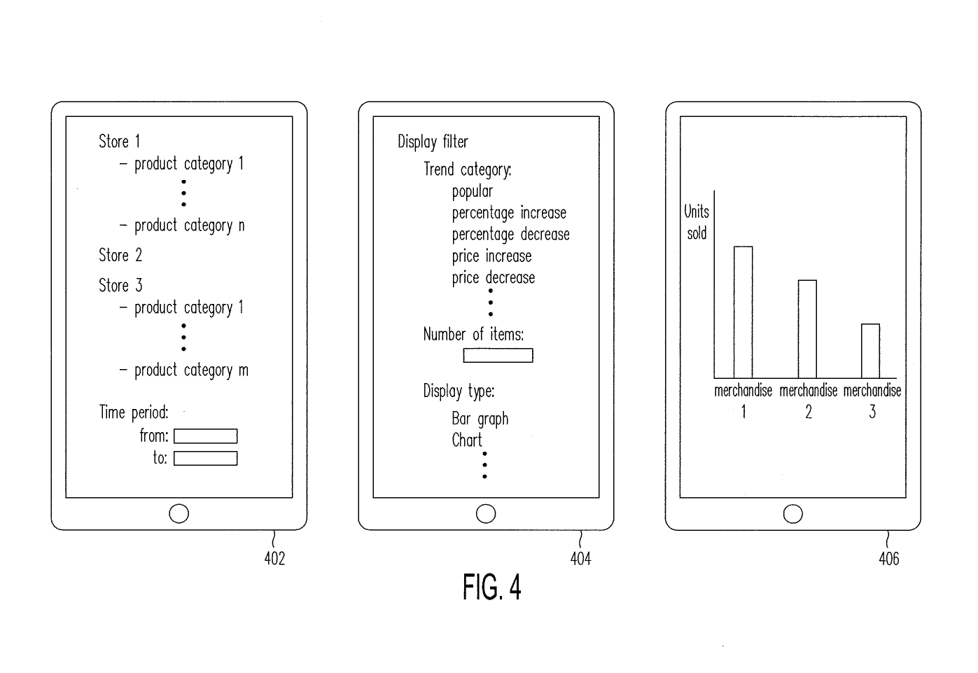

FIG. 4 shows a sequence of displays from a product trend application running on a user device for a user to specify requirements for personalized product trend information and to display the information according to one or more embodiments of the present disclosure.

Display 402 shows a listing of stores and the product categories of products carried by the stores for which payment service provider 130 has product trend information. The stores are located within a certain radius of the current location of user device 102 where the radius may be selected by user device 102 or by payment service provider 130. As shown, store 1 carries products for product categories 1 through n. If a product category has subcategories, user 100 may select the product category to display the subcategories. For example, a product category may be a general product category such as consumer electronics and may be selected to show subcategories for TVs, laptops, smart phones, etc. Store 2 does not show any product category, possibly because store 2 only has one category of products. As such, when store 2 is selected, product trend information for all products purchased from store 2 will be provided. Store 3 carries products for product categories 1 through m. User 100 may select a store and a product category to request product trend information for products under the product category purchased from the store. The product category selected may be a general product category or may be any of the subcategories under the general product category.

Display 402 also shows fields for user 100 to specify a time period over which the product trend information is desired. When user 100 enters a starting date for the “from” field and an ending date for the “to” field, product trend information for products purchased between the starting date and the ending date is be provided.

Display 404 shows a menu of display filters for user 100 to specify how product trend information for a product category is processed and displayed. The display filters include a trend category listing the different types of product trends. The “popular” trend category processes the product trend information to display the most popular products for a product category as determined by the quantities of the products purchased during a specified time period. The “percentage increase” trend category processes the product trend information to display the products with the largest percentage increase in the quantities sold for a product category from the beginning of the time period to the end of the time period. Thus, user 100 may obtain product trend information for products that exhibit the largest increase in popularity for a product category during the time period. Similarly, the “percentage decrease” trend category processes the product trend information to display the products with the largest percentage decrease in the quantities sold for a product category from the beginning of the time period to the end of the time period. The “price increase” and the “price decrease” trend categories process the product trend information to display the products with the largest percentage increase and decrease in price, respectively, for a product category from the beginning of the time period to the end of the time period.

Display 404 also shows a field for user 100 to enter number of products to display for the selected trend category. If user 100 enters a number of products greater than the number of products in a product category, the display will display the trend category for the number of products in the product category. Display 404 also shows selections for display type that allows user 100 to select a bar graph, a chart, etc., to display the product trend information.

Display 406 shows a product trend information display when user 100 selects the “popular” trend category, enters 3 for the number of items, and selects the bar graph for the display filters of display 404. As shown, the bar graph displays the quantities for the three most popular products in a selected product category purchased from a selected store over the specified time period.

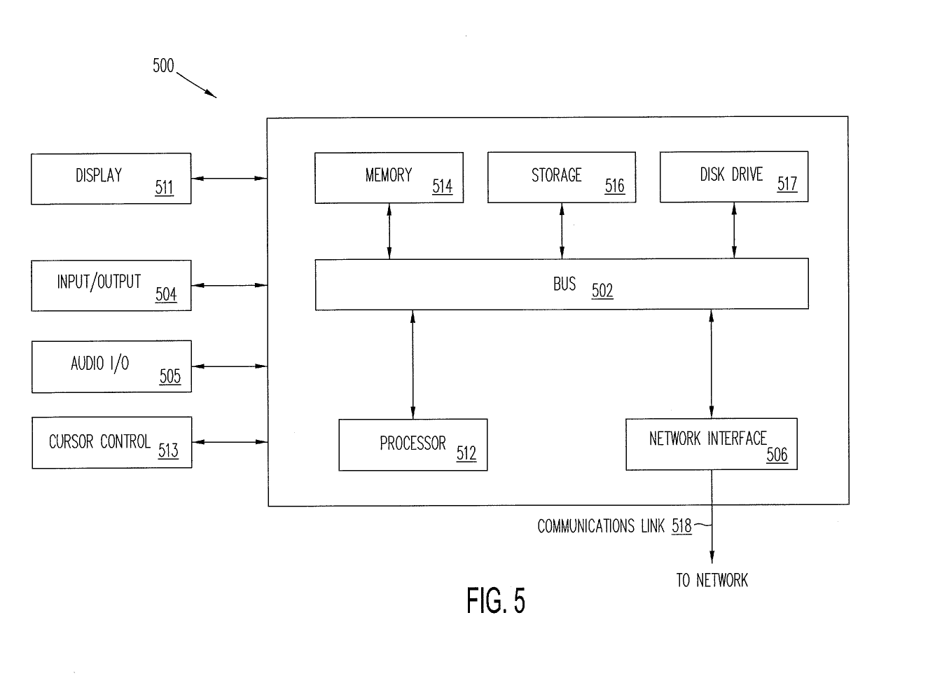

FIG. 5 is a block diagram of a computer system 500 suitable for implementing one or more embodiments of the present disclosure. In various implementations, the mobile device of the user may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 500 in a manner as follows. It should also be appreciated that the toll-free number and the services to accept orders, manage inventories, and process payments may be implemented as applications running on computer system 500.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons or links, etc., and sends a corresponding signal to bus 502. I/O component 504 may also include an output component such as a display 511, and an input control such as a cursor control 513 (such as a keyboard, keypad, mouse, etc.). An optional audio input/output component 505 may also be included to allow a user to use voice for inputting information by converting audio signals into information signals. Audio I/O component 505 may allow the user to hear audio. A transceiver or network interface 506 transmits and receives signals between computer system 500 and other devices, such as another user device, a merchant server, or a payment provider server via a communication link 518 to a network. In one embodiment, the transmission is wireless, although other transmission mediums and methods may also be suitable. A processor 512, which can be a micro-controller, digital signal processor (DSP), or other processing component, processes these various signals, such as for display on computer system 500 or transmission to other devices via communication link 518. Processor 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor 512 and other components by executing one or more sequences of instructions contained in system memory component 514. Logic may be encoded in a computer readable medium, which may refer to any medium that participates in providing instructions to processor 512 for execution. Such a medium may take many forms, including but not limited to, non-volatile media, volatile media, and transmission media. In various implementations, non-volatile media includes optical, or magnetic disks, or solid-state drives, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Application software in accordance with the present disclosure, such as computer programs executed by a processor of the payment service provider to administer the toll-free number and the services to accept orders, manage inventories, and process payments, may be stored on one or more computer readable mediums. It is also contemplated that the application software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although embodiments of the present disclosure have been described, these embodiments illustrate but do not limit the disclosure. For example, even though a method is described for a user device to receive product trend information for stores in the vicinity of the user device, the method may be extended to receive product trend information for stores in other locations, or for on-line merchants. Similarly, even though a payment service provider is described as providing the product trend information, other entities, including the stores, may provide the information. It should also be understood that embodiments of the present disclosure should not be limited to these embodiments but that numerous modifications and variations may be made by one of ordinary skill in the art in accordance with the principles of the present disclosure and be included within the spirit and scope of the present disclosure as hereinafter claimed.

1. An apparatus comprising:
one or more processors;
a database adapted to store information on one or more stores and information on products purchased by all consumers from the one or more stores, wherein the information on the stores and the information on products purchased from the stores are compiled from information provided when the apparatus processes payment transactions of products purchased from the stores;
a memory adapted to store a plurality of machine-readable instructions wherein the memory is executed by the one or more processors to:
receive from a communication device a device location;
search the database to obtain information on one or more stores in a vicinity of the device location, wherein the information on the one or more stores includes one or more product categories of products carried by each of the one or more stores, and wherein the database has product trend information for the products in the product categories purchased by the consumers;
transmit the information on the one or more stores in the vicinity of the device location to the communication device;
receive from the communication device selections for product trend information for a selected store of the one or more stores in the vicinity of the device location;
search the database to obtain product trend information from the information on products purchased from the selected store, wherein the products purchased satisfy the selections for product trend information; and
transmit the product trend information to the communication device.

2. The apparatus of claim 1, wherein the information on the one or more stores in the database comprises a location of each of the one or more stores.

3. The apparatus of claim 1, wherein the information on products purchased from the one or more stores in the database comprises a product name, a product category, and a quantity purchased for each of the products purchased from the one or more stores.

4. The apparatus of claim 3, wherein the selections for product trend information for the selected store comprise a selected product category for the selected store, and wherein the product trend information comprises the product names and the quantities purchased for one or more products whose product category matches the selected product category and wherein the products are purchased from the selected store.

5. The apparatus of claim 3, wherein the information on products purchased in the database further comprises a date of purchase for each of the products purchased, wherein the selections for product trend information for the selected store comprises a selected product category and a purchase period for the selected store, and wherein the product trend information comprises the product names, the quantities purchased, and the dates of purchase for one or more products whose product category matches the selected product category, whose dates of purchase match the purchase period, and which are purchased from the selected store.

6. The apparatus of claim 1, wherein the one or more stores in the vicinity of the device location comprise one or more stores within a given radius of the device location.

7. An apparatus comprising:
one or more processors;
a memory adapted to store a plurality of machine-readable instructions wherein the memory is executed by the one or more processors to:
transmit a location of the apparatus to a service provider;
receive from the service provider store information on one or more stores in a vicinity of the location of the apparatus, wherein the store information includes one or more product categories of products carried by each of the one or more stores, and wherein the service provider has product trend information for the products in the product categories purchased by all consumers;
identify a selected store and selections for product trend information for products purchased from the selected store based on the store information on the one or more stores;
transmit to the service provider a request for product trend information, wherein the request comprises the selected store and the selections for product trend information for products purchased from the selected store;
receive from the service provider the product trend information for products purchased from the selected store, wherein the products satisfy the selections for product trend information, and wherein the store information and the product trend information for products purchased from the selected store are compiled by the service provider from information provided when the service provider processes payment transactions of products purchased by the consumers from the selected store; and
process the product trend information in accordance with selections for display filters to display the product trend information.

8. The apparatus of claim 7, wherein the store information on the one or more stores in the vicinity of the location of the apparatus comprises a location of each of the one or more stores.

9. The apparatus of claim 8, wherein the selected store is one of the one or more stores in the vicinity of the location of the apparatus, and wherein the selections for product trend information for products purchased from the selected store comprise a selected product category chosen from the one or more product categories of products carried by the selected store.

10. The apparatus of claim 9, wherein the product trend information comprises product names and quantities purchased for one or more products whose product category matches the selected product category and wherein the products are purchased from the selected store.

11. The apparatus of claim 10, wherein the selections for display filters comprise a selection to display the product name that has the most quantity purchased out of the one or more products whose product category matches the selected product category and are purchased from the selected store.

12. A method comprising:
receiving by a processor a device location of a device;
searching by the processor a database to obtain store information on one or more stores in a vicinity of the device location, wherein the database stores information on stores and information on products purchased by all consumers from the stores, wherein the information stored in the database are compiled by the processor from information provided when the processor processes payment transactions of products purchased from the stores, wherein the store information on the one or more stores includes one or more product categories of products carried by each of the one or more stores, and wherein the database has product trend information for the products in the product categories purchased by the consumers;
transmitting by the processor store information on the one or more stores to the device;
receiving by the processor selections for product trend information on products purchased from a selected store of the one or more stores;
searching by the processor the database to obtain product trend information on products purchased from the selected store, wherein the products purchased satisfy the selections for product trend information; and
transmitting by the processor the product trend information to the device.

13. The method of claim 12, wherein the store information on the one or more stores comprises a location of each of the one or more stores.

14. The method of claim 12, wherein the selections for product trend information on products purchased from the selected store comprise a selected product category for the selected store, and wherein the product trend information comprises product names and quantities purchased for one or more products whose product category matches the selected product category and wherein the products are purchased from the selected store.

15. The method of claim 12, wherein the selections for product trend information on products purchased from the selected store comprise a selected product category and a purchase period for the selected store, and wherein the product trend information comprises product names, quantities purchased, and dates of purchase for one or more products whose product category matches the selected product category, whose dates of purchase match the purchase period, and which are purchased from the selected store.

16. A method, comprising:
obtaining by a communication device a device location;
transmitting by the communication device the device location to a provider of product trend information;
receiving by the communication device from the provider store information on one or more stores in a vicinity of the device location, wherein the store information includes one or more product categories of products carried by each of the one or more stores, and wherein the provider has product trend information for the products in the product categories purchased by all consumers;
identifying by the communication device a selected store and selections for product trend information for products purchased from the selected store based on the store information on the one or more stores;
transmitting by the communication device a request for product trend information to the provider, wherein the request comprises the selected store and the selections for product trend information for products purchased from the selected store;
receiving by the communication device from the provider the product trend information for products purchased by from the selected store, wherein the products satisfy the selections for product trend information, and wherein the store information and the product trend information for products purchased from the selected store are compiled by the provider from information provided when the provider processes payment transactions of products purchased by the consumers from the selected store; and
processing by the communication device the product trend information in accordance with selections for display filters to display the product trend information.

17. The method of claim 16, wherein the store information on the one or more stores in the vicinity of the device location comprises a location of each of the one or more stores.

18. The method of claim 17, wherein the selected store is one of the one or more stores in the vicinity of the device location, and wherein the selections for product trend information for products purchased from the selected store comprise a selected product category chosen from the one or more product categories of products carried by the selected store.

19. The method of claim 18, wherein the product trend information comprises product names and quantities purchased for one or more products whose product category matches the selected product category and wherein the products are purchased from the selected store.

20. A non-transitory computer readable medium having computer readable code for instructing a processor to perform a method, the method comprising:
receiving a device location of a device;
searching a database to obtain store information on one or more stores in a vicinity of the device location, wherein the database stores information on stores and information on products purchased by all consumers from the stores, wherein the information stored in the database are compiled from information provided when payment transactions of products purchased from the stores are processed, wherein the store information on the one or more stores includes one or more product categories of products carried by each of the one or more stores, and wherein the database has product trend information for the products in the product categories purchased by the consumers;
transmitting store information on the one or more stores to the device;
receiving selections for product trend information on products purchased from a selected store of the one or more stores;
searching the database to obtain product trend information on products purchased from the selected store, wherein the products purchased satisfy the selections for product trend information; and
transmitting the product trend information to the device.
